(19) United States
(12) Patent Application Publication
(10) Pub. No.: US 2016/0082473 A1
(43) Pub. Date: Mar. 24, 2016

(54) SUBSTRATE PRE-TREATING USING PHOTOINITIATORS

(71) Applicant: CIMA NANOTECH ISRAEL LTD., Caesarea (IL)

(72) Inventor: Arkady Garbar, Burnsville, MN (US)

(21) Appl. No.: 14/785,586

(22) PCT Filed: May 28, 2014
(86) PCT No.: PCT/US14/39694

§ 371 Date: Oct. 19, 2015

Related U.S. Application Data
(60) Provisional application No. 61/828,379, filed on May 29, 2013.

(51) Int. Cl. B05D 3/06; C08J 7/04; C08J 7/06; B05D 7/02

(52) U.S. Cl. CPC B05D 3/063; B05D 7/02; C08J 7/047; C08J 7/065; C08J 2367/02; C08J 2401/28

(57) ABSTRACT

A method for preparing a coated substrate that includes (a) applying a photoinitiator to a surface of a substrate; (b) exposing the photoinitiator to ultraviolet or ultraviolet-visible radiation to activate the photoinitiator and form a pre-treated surface; and (c) applying a coating composition to the pre-treated substrate to form a coated substrate. The coating composition may be a nanoparticle-containing emulsion.

### CROSS-REFERENCE TO RELATED APPLICATIONS

This application claims the benefit of U.S. Provisional Application Ser. No. 61/828,379, filed May 29, 2013. The disclosure of the prior application is considered part of (and is incorporated by reference in) the disclosure of this application.

### TECHNICAL FIELD

This invention relates to pre-treating substrates prior to coating.

### BACKGROUND

Coating processes often require treating the substrate prior to coating to improve properties such as adhesion, wetting uniformity, and compatibility between the substrate and the coating. Such pre-treatments may alter the nature of the substrate surface by modifying the surface chemistry. Known pre-treatments include chemical primers, corona exposure, plasma exposure, and ultraviolet (UV) exposure. The pre-treatment may be done in line with the coating step, or may be done separately.

UV activation of polyethylene terephthalate (PET) substrates prior to coating with a self-assembling emulsion to form a transparent conductive coating is described in Garbar et al., WO 2009/149249 entitled “Processes for Making Transparent Conductive Coatings.” Line speeds between 1.1 m/min. and 2.7 m/min. are described.

### SUMMARY

A method for preparing a coated substrate is described that includes (a) applying a photoinitiator to a surface of a substrate; (b) exposing the photoinitiator to ultraviolet or ultraviolet-visible radiation to activate the photoinitiator and form a pre-treated surface; and (c) applying a coating composition to the pre-treated substrate to form a coated substrate. The coating composition may be a nanoparticle-containing emulsion. Pre-treating the substrate with a photoinitiator enables the preparation of coated substrates with higher line speeds relative to substrates pre-treated by exposure to ultraviolet or ultraviolet-visible radiation alone.

The details of one or more embodiments of the invention are set forth in the accompanying drawings and the description below. Other features, objects, and advantages of the invention will be apparent from the description and from the claims.

### DETAILED DESCRIPTION

Examples of suitable substrates include polymeric films or sheets such as polyesters, polyamides, polyimides, polycarbonates, polyolefins, poly(meth)acrylates, copolymers, and multilayer films. The substrates may be rigid or flexible for roll to roll processing.

Examples of suitable photoinitiators include molecules that absorb UV or UV-visible light and generate free radicals. Single photoinitiators may be used or mixtures of photoinitiators may be used, including synergistic photoinitiator systems, e.g., binary or Type II photoinitiator systems. Photoinitiators are chosen such that the absorption wavelength of the photoinitiator overlaps with the emission wavelength of the light source (e.g. UV lamps or LEDs) used for initiation.

One useful class of photoinitiators includes alpha-hydroxy ketones. A commercially available example of a photoinitiator within this class is Irgacure 184, available from BASF Resins.

Photoinitiators may be dissolved in solvents at concentrations in the range of 0.1-10% by weight. Factors to consider when choosing sovents or solvent mixtures include solubility of the photoinitiator, volatility of the solvent, and compatibility of the solvent with the substrate and coating process.

The photoinitiator solution may be deposited on the substrate by a variety of techniques including bar spreading, immersing, spin coating, dipping, slot die coating, gravure coating, flexographic plate printing, spray coating, or any other suitable technique. Wet coating thicknesses may be from 1-100 μm, preferably 1-10 μm. After deposition, the photoinitiator solution may be dried under ambient conditions or the drying may be accelerated by using elevated temperatures and/or air flow, depending on the choice of photoinitiator and solvent (e.g. temperatures should not be so high as to cause volatilization of the photoinitiator). In the case of in line processes, the drying conditions and solvent should be chosen for rapid drying.

After the photoinitiator solution is dry, the pre-treated substrate is exposed to a UV or visible radiation source such as e.g., a mercury lamp or LEDs to activate the photoinitiator. The wavelength, intensity, and exposure time (e.g. as determined by line speed) of the radiation source is chosen to be effective for activating the particular photoinitiator chosen.

Following the photoinitiator activation, the substrate is coated with the selected coating composition. Preferably, the time between the photoinitiator activation and the coating step is minimized to preserve the effectiveness of the activation, which may decrease with the passage of time.

Coatings useful with the photoinitiator pre-treatment include solutions, dispersions, or emulsions. Solutions may include solvent based coatings or may be 100% solids (e.g. 100% monomers or monomer blends). Dispersions may include a particulate component dispersed in a solvent. Coatings may include adhesive coatings, protective coatings (e.g. hard coats or UV-blocking coatings), optical coatings, conductive coatings, release coatings, antimicrobial coatings, printing, and the like.

Emulsion coatings may include coatings that self-assemble into a network of traces and cells. The emulsion applied to the pre-treated substrate includes a continuous liquid phase and a dispersed liquid phase that is immiscible with the continuous liquid phase and forms dispersed domains within the continuous liquid phase. In some implementations, the continuous phase evaporates more quickly than the dispersed phase. One example of a suitable emulsion is a water-in-oil emulsion, where water is the dispersed liquid phase and the oil provides the continuous phase. The emulsion can also be in the form of an oil-in-water emulsion, where oil provides the dispersed liquid phase and water provides the continuous phase.

The continuous phase can include an organic solvent. Suitable organic solvents may include petroleum ether, hexanes, heptanes, toluene, benzene, dichloroethane, trichloroethylene, chloroform, dichloromethane, nitromethane, dibromomethane, cyclopentanone, cyclohexanone or any mixture thereof. Preferably, the solvent or solvents used in this continuous phase are characterized by higher volatility than that of the dispersed phase, e.g., the water phase.

Suitable materials for the dispersed liquid phase can include water and/or water miscible solvents such as methanol, ethanol, ethylene glycol, propylene glycol, glycerol, dimethyl formamide, dimethyl acetamide, acetonitrile, dimethyl sulfoxide, N-methyl pyrrolidone.

The emulsion may also contain at least one emulsifying agent, binder or any mixture thereof. Suitable emulsifying agents can include non-ionic and ionic compounds, such as the commercially available surfactants SPAN®-20 (Sigma-Aldrich Co., St. Louis, Mo.), SPAN®-40, SPAN®-60, SPAN®-80 (Sigma-Aldrich Co., St. Louis, Mo.), glyceryl monooleate, sodium dodecylsulfate, or any combination thereof. Examples of suitable binders include modified cellulose, such as ethyl cellulose with a molecular weight of about 100,000 to about 200,000, and modified urea, e.g., the commercially available BYK® -410, BYK® -411, and BYK®-420 resins produced by BYK-Chemie GmbH (Wesel, Germany).

Other additives may also be present in the oil phase and/or the water phase of the emulsion formulation. For example, additives can include, but are not limited to, reactive or non-reactive diluents, oxygen scavengers, hard coat components, inhibitors, stabilizers, colorants, pigments, IR absorbers, surfactants, wetting agents, leveling agents, flow control agents, thixotropic or other rheology modifiers, slip agents, dispersion aids, defoamers, humectants, and corrosion inhibitors.

The emulsion may also include metal nanoparticles. The metal nanoparticles may include conductive metals or mixtures of metals including metal alloys selected from, but not limited to, the group of silver, gold, platinum, palladium, nickel, cobalt, copper. Preferred metal nanoparticles include silver, silver-copper alloys, silver palladium, or other silver alloys or metals or metals alloys produced by a process known as Metallurgic Chemical Process (MCP) described in U.S. Pat. Nos. 5,476,535 and 7,544,229.

Specific examples of suitable emulsions are described in U.S. Pat. No. 7,566,360, which is incorporated by reference in its entirety. These emulsion formulations generally comprise between 40 and 80 percent of an organic solvent or mixture of organic solvents, from 0 to 3 percent of a binder, 0 to 4 percent of an emulsifying agent, 2 to 10 percent of metal powder and 15 to 55 percent of water or water miscible solvent.

The coating composition can be prepared by mixing all components of the emulsion. The mixture can be homogenized using an ultrasonic treatment, high shear mixing, high speed mixing, or other known methods used for preparation of suspensions and emulsions.

The composition can be coated onto the pre-treated substrate using bar spreading, immersing, spin coating, dipping, slot die coating, gravure coating, flexographic plate printing, spray coating, or any other suitable technique. In some implementations, the homogenized coating composition is coated onto the pre-treated substrate until reaching a thickness of about 1 to 200 microns, e.g., 5 to 200 microns.

After applying the emulsion to the pre-treated substrate, the liquid portion of the emulsion is evaporated, with or without the application of heat. When the liquid is removed from the emulsion, the nanoparticles self-assemble into a network-like pattern of traces defining cells that are transparent to light.

In some implementations, the cells are randomly shaped. In other implementations, the process is conducted to create cells having a regular pattern. An example of such a process is described in WO 2012/170684 entitled “Process for Producing Patterned Coatings,” filed Jun. 10, 2011, which is assigned to the same assignee as the present application and hereby incorporated by reference in its entirety. According to this process, the composition is coated on a surface of the pre-treated substrate and dried to remove the liquid carrier while applying an outside force during the coating and/or drying to cause selective growth of the dispersed domains, relative to the continuous phase, in selected regions of the pre-treated substrate. Application of the outside force causes the non-volatile component (the nanoparticles) to self-assemble and form a coating in the form of a pattern that includes traces defining cells having a regular spacing (for instance, a regular center-to-center spacing), determined by the configuration of the outside force. Application of the outside force may be accomplished, for example, by depositing the composition on the pre-treated substrate surface and then passing a Mayer rod over the composition. Alternatively, the composition can be applied using a gravure cylinder. In another implementation, the composition may be deposited on the pre-treated substrate surface, after which a lithographic mask is placed over the composition. In the case of the mask, as the composition dries, the mask forces the composition to adopt a pattern corresponding to the pattern of the mask.

In each case, it is the outside force that governs the pattern (specifically, the center-to-center spacing between cells in the dried coating). However, the width of the traces defining the cells is not directly controlled by of the outside force. Rather, the properties of the emulsion and drying conditions are the primary determinant of the trace width. In this fashion, lines substantially narrower than the outside force can be readily manufactured, without requiring the difficulty and expense of developing processes, masters, and materials having very fine linewidth. Fine linewidth can be generated with the emulsion and drying process. However, the outside force can be used (easily and inexpensively) to control the size, spacing, and orientation of the cells of the network.

Following liquid removal and formation of the self-assembled layer, the layer may be sintered using thermal, laser, ultraviolet, laser, or other treatments and/or exposure to chemicals such as metal salts, bases, or ionic liquids.

### EXAMPLES

TABLE 1
Glossary

| | | Chemical | |
|---|---|---|---|
| Component | Function | description | Source |
| BYK-410 | Liquid | Solution of a modified | BYK USA, |
| | rheology | urea | Wallingford, CT |
| | additive | | |
| K-Flex A307 | Flexibility | Linear, saturated, | King Industries, |
| | modifier | aliphatic polyester diol | Norwalk, CT |
| | | with primary hydroxyl | |
| | | groups | |
| Span 60 | | Sorbitan monostearate | Sigma-Aldrich, |
| | | | St. Louis, MO |
| Nacure 2501 | Blocked acid | Amine blocked | King Industries |
| | catalyst | toluenesulfonic acid | |
| BYK-348 | Silicone | Polyether modified | BYK USA |
| | surfactant | polydimethylsiloxane | |
| Silver | | Silver nanoparticles | Cima |
| nanoparticle | | | Nanotech, Inc., |
| powder P204 | | | Israel |
| Q4-3667 | | Silicone polyether | Dow Corning, |
| fluid | | (glycol) copolymer | Midland, MI |
| Ethyl | | Ethyl | Sigma-Aldrich |
| cellulose | | cellulose | |
| Synperonic | Nonionic | Polyethylene glycol | Fluka, Sigma- |
| NP-30 | surfactant | nonylphenyl ether | Aldrich |
| Cymel 303 | Cross-linking | Hexamethoxymethyl | Cytec |
| LF | agent | melamine | Industries, |
| | | | Woodland |
| | | | Park, NJ |
| SR 238B | Diacrylate | 1,6-Hexanediol | Sartomer Co., |
| | monomer | diacrylate | Exton, PA |
| Irgacure 184 | Photoinitiator | 1-hydroxy-cyclohexyl | BASF Resins, |
| | | phenyl ketone | Florham Park, NJ |
| E100 | Polyester Film | PET film available as | Mitsubishi |
| | Substrate | E100 | Polyester Film, |
| | | | Mitsubishi, |
| | | | Japan |
| U46 | Polyester Film | PET film available as | Toray |
| | Substrate | Lumirror U46 | Industries, |
| | | | Japan |

### Test Methods

% Transmittance (%T): % Transmittance is the average percent of light that is transmitted through a sample at wavelengths between 400-740 nm with a 20 nm resolution as measured by a GretagMacbeth Color Eye 3000 Spectrophotometer with an integrated sphere (X-rite Corp, Grand Rapids, Mich.). In general, the higher the % transmittance value, the better the quality of the final coating.

### Photoinitiator Coating and UV Activation

Photoinitiators were dissolved in acetone and coated onto the PET substrates using a Mayer rod having a 6 μm wet thickness. The coating was dried at room temperature for 1 min. and UV activated by passing through a system having an F300S UV curing lamp with an H-bulb on an LC6B Conveyor (Fusion UV Systems Inc., Gaithersburg, Md.).

### Emulsion

The components shown in Table 2 were mixed in the following manner. All of the components except the D.I. water were mixed until uniform using an ultrasonic homogenizer to form a dispersion. Next, the D.I. water was added and mixed using an ultrasonic homogenizer to form a uniform emulsion.

The uniform emulsion was coated onto the PET film using a Mayer rod at 30 μm wet thickness. The coated films were dried at 50° C., during which time the conductive network self-assembled and dried.

TABLE 2
Emulsion components

| Component | Wt. % |
|---|---|
| BYK 410 | 0.155 |
| Span 60 | 0.127 |
| Cyclohexanone | 4.575 |
| P204 | 4.034 |
| Toluene | 50.519 |
| Cymel 303 LF | 0.117 |
| Kflex A307 | 0.245 |
| Nacure 2501 | 0.237 |
| Q4-3667 (5 wt % in | 0.587 |
| toluene) | |
| Ethyl cellulose (5 wt | 0.703 |
| % in toluene) | |
| Synperonic NP-30 (1 | 0.428 |
| wt % in toluene) | |
| 2-amino-1-butanol | 0.128 |
| Aniline | 0.073 |
| D.I. Water with 0.02 | 38.07 |
| wt % BYK 348 | |

### Example 1 (Comparative)

Pieces of E100 PET were passed through the UV system at a speed of 25 ft./min. (7.62 m/min.). One piece of film was passed through the system once, another piece was passed through twice, and another piece was passed through three times. Next, the pieces of PET were coated with the emulsion as described above.

The coated films were tested for % transmittance with the following results:

one pass: 61.0% T

two passes: 75.2% T

three passes: 79.4% T.

### Example 2

Pieces of E100 PET were coated with a 0.283 wt. % solution of Irgacure 184 in acetone and UV activated as described above. One piece of coated film was passed through the UV system at 25 ft./min. (7.62 m/min.), and a second piece was passed through at 20 ft./min. (6.10 m/min.). Next, the pieces of PET were coated with the emulsion as described above.

The coated films were tested for % transmittance with the following results:

7.62 m/min.: 78.1% T

6.10 m/min.: 78.8% T.

### Example 3 (Comparative)

Pieces of U46 PET were passed through the UV system at a speed of 25 ft./min. (7.62 m/min.). One piece of film was passed through the system once, another piece was passed through twice, and another piece was passed through three times. Next, the pieces of PET were coated with the emulsion as described above.

The coated films were tested for % transmittance with the following results:

one pass: 67.2% T

two passes: 77.3% T

three passes: 81.6% T.

### Example 4

Pieces of U46 PET were coated with a 0.283 wt. % solution of Irgacure 184 in acetone and UV activated as described above. One piece of coated film was passed through the UV system at 25 ft./min. (7.62 m/min.), a second piece was passed through at 35 ft./min. (10.67 m/min.), and a third piece was passed through at 45 ft./min. (13.72 m/min.). Next, the pieces of PET were coated with the emulsion as described above.

The coated films were tested for % transmittance with the following results:

7.62 m/min.: 80.5% T

10.67 m/min.: 80.0% T

13.72 m/min.: 80.2% T.

A number of embodiments of the invention have been described. Nevertheless, it will be understood that various modifications may be made without departing from the spirit and scope of the invention. Accordingly, other embodiments are within the scope of the following claims.

What is claimed is:

1. A method for preparing a coated substrate comprising:
(a) applying a photoinitiator to a surface of a substrate;
(b) exposing the photoinitiator to ultraviolet or ultraviolet-visible radiation to activate the photoinitiator and form a pre-treated surface; and
(c) applying a coating composition to the pre-treated substrate to form a coated substrate.

2. The method of claim 1 wherein the coating composition comprises an emulsion that includes nanoparticles dispersed in a liquid, where the liquid comprises (i) an oil phase comprising a solvent that is non-miscible with water and (ii) a water phase comprising water or a water-miscible solvent.
